(19) United States
(12) Patent Application Publication
(10) Pub. No.: US 2007/0131489 A1
(43) Pub. Date: Jun. 14, 2007

(54) Elevator installation with equipment for compensation for the weight difference between the cage runs and the counterweight runs of the support means and method of realizing such compensation

(76) Inventor: Robert Stalder, Rickenbach (CH)

Correspondence Address: Klaus P. Stoffel;Wolff & Samson PC, One Boland Drive, West Orange, NJ, 07052, US

(21) Appl. No.: 11/603,600

(22) Filed: Nov. 21, 2006

(30) Foreign Application Priority Data
Nov. 28, 2005 (EP) 05111383.5

(51) Int. Cl. B66B 17/12

(52) U.S. Cl. 187/404

(57) ABSTRACT

In an elevator installation with an elevator cage, a counterweight and at least one hanging cable with integrated conductors for transmission of energy and/or control signals compensation is provided for the weight difference between the cage runs and the counterweight runs of the support by hanging cables hanging between a fixing point of the elevator installation and the elevator cage or the counterweight, wherein the hanging cable includes an arrangement for increasing its weight per meter.

### BACKGROUND OF THE INVENTION

The invention relates to an elevator installation with equipment for compensating for the weight difference, which is dependent on the position of the elevator cage, between the cage runs, which support the elevator cage, and the counterweight runs, which support the counterweight, of the support means, and to a method of realizing such a compensation.

An elevator installation is known from EP 1445229 which comprises an elevator cage and a counterweight, a drive unit with a drive pulley and support means running over the drive pulley, wherein a flexible weight compensating strand is installed between the elevator cage and a shaft wall parallel to a hanging cable with lines for the transmission of energy or control signals. This weight compensating strand can be present, for example, as a link chain or in the form of wire cables or belts and extends in the form of a hanging loop from a fixing point, which is disposed at approximately half the height of the elevator installation, to the underside of the elevator cage. Without compensation equipment the combination of support means sections which are long at the cage side and short at the counterweight side exert—for example in the lowermost position of the elevator cage—a substantial torque on the drive pulley. In the uppermost position of the elevator cage the combination of support means sections which are short at the cage side and long at the counterweight side exert a torque in the other direction of rotation on the drive pulley. Without compensating equipment, the drive unit has to apply, depending on the respective load situation, this torque additionally to the torque which results from the weight difference between cage and counterweight. In the elevator installation according to EP 1445229 compensation is provided for the described, undesired weight influence of the support means by a weight compensating strand or several weight compensating strands, the weight per meter approximately corresponds with twice the weight per meter of all support means arranged in parallel.

The elevator installation disclosed in EP 1445229 has certain disadvantages. One of the disadvantages consists in that apart from the hanging cable with the integrated conductors for transmission of energy or of control signals at least one separate flexible weight compensating strand, which is arranged parallel to the hanging cable, has to be installed. This has the consequence of additional costs for the weight compensating strand itself and also for production, stocking and mounting thereof. A further disadvantage is to be seen in the fact that such flexible weight compensating strands are available only in a limited number of variants with respect to their weight per meter. An optimum compensation of the weight difference between the cage runs and the counterweight runs of the support means, which have different weights per meter according to the respective elevator configuration, therefore often cannot be realized. Moreover, the stocking, which is required in several weight per meter variants, of such weight compensating strands, as also the additionally required logistical outlay, cause substantial increased costs. In elevator installations with transparent shafts additional weight compensating strands moreover impair the appearance of the entire installation.

### SUMMARY OF THE INVENTION

The invention has the object of proposing an elevator installation which does not have the stated disadvantages of the elevator installation cited as state of the art. In particular, an elevator installation with equipment for compensation for the weight difference between the runs at the cage side (cage runs) and the runs at the counterweight side (counterweight runs) of the support means shall thus be created which do not oblige an additional weight compensating strand and thereby save costs for production; logistics and mounting, can be so adapted to all conditions of an elevator installation that optimum compensation is provided for the undesired weight difference between the cage runs and the counterweight runs of the support means, and impair the appearance an elevator installation with a transparent shaft as little as possible.

The object is fulfilled by an elevator installation according to the invention as well as by a method according to the invention. In the case of the elevator installation according to the invention, a hanging cable with integrated conductors for transmission of energy and/or control signals is present, which provides compensation at least partly for the weight difference between the cage runs and the counterweight runs of the support means. The hanging cable comprises means for increasing its weight per meter.

By the term “weight per meter” there is understood the weight, relative to a meter length, of a hanging cable or a support means.

In the method according to the invention a hanging cable with integrated conductors for transmission of energy and/or control signals, which is provided with means for increasing its weight per meter, is installed in an elevator installation for compensation of the weight difference between the cage runs and the counterweight runs of the support means.

The invention is accordingly based on the concept of so increasing the weight per meter of hanging cables, which are present in any case and which contain integrated conductors for transmission of energy and/or control signals, by suitable measures that they provide compensation for the undesired weight difference between the cage runs and the counterweight runs of the support means, which have different lengths depending on the respective instantaneous position of the elevator cage.

The advantages achieved by the invention are substantially to be seen in that it is possible to dispense with additional weight compensating strands together with all their aforementioned disadvantages.

In a preferred embodiment of the invention, weight elements are fixed along the hanging cable. With this simple embodiment commercially available hanging cables can be so equipped that compensation can be provided for them in an optimum manner for the undesired weight influence of the support means.

Advantageously the weight elements are fixed to the hanging cable at regular intervals.

The invention can be realized in particularly simple manner if the hanging cable with the integrated conductors is a flat cable, wherein weight elements are fixed on only one or both of the flat sides of the hanging cable.

A simple and time-saving mounting of the weight elements on the hanging cable is achieved in that fastening holes, through which fastening elements for fixing the weight elements can be inserted, are present along the hanging cable at regular intervals.

Commercially available and thus favorably priced hanging cables can be used if weight elements—preferably plate-shaped—along the hanging cable are fixed thereto at regular intervals exclusively by clamping fast.

Advantageously, markings—for example colored markings or impressions in the casing of the hanging cable—which facilitate positioning of the weight elements at regular intervals are present along the hanging cable at regular intervals.

If for compensation of the weight difference between the cage runs and the counterweight runs of all support means two or more hanging cables arranged in parallel are required, it is advantageous to connect the parallely arranged hanging cables together with plate-shaped weight elements of corresponding width. The group of hanging cables can be stabilized by this measure against oscillations in all horizontal directions.

In one embodiment of the invention, which requires low logistical and mounting expenditures, cavities which are at least partly filled with-increasing filling materials are present, for increasing the weight per meter, in the casing of the hanging cable additionally to energy and/or signal lines. Sand, steel scrap, lead scrap, or metal strips rendered flexible by transverse notches, etc., come into question as such filling materials.

Advantageously the cavities are present in the form of continuous longitudinal channels in the hanging cable, wherein expediently the filling of these cavities with the weight-increasing filling materials takes place during the production of the hanging cable, for example, in the extruding process.

A high level of flexibility of the method according to the invention is achieved in that the weight per meter of the hanging cable is adapted to a given situation in that the spacing between the individual weight elements or the weight of the individual weight elements or not only the spacing, but also the weight of the weight elements is or are correspondingly selected.

According to a particularly preferred embodiment of the invention, compensation for the weight difference between the cage runs and the counterweight runs of the support means is provided completely and exclusively by at least one hanging cable having means for increasing its weight per meter.

Other features and advantages of the present invention will become apparent from the following description of the invention that refers to the accompanying drawings.

### BRIEF DESCRIPTION OF THE DRAWINGS

Embodiments of the invention are explained in the following by way of the accompanying drawings, wherein the respective first numeral of the reference designation corresponds with the number of the figure in which the item denoted by the reference designation is illustrated and wherein:

FIG. 1A shows a schematic cross-section through an elevator installation with an elevator cage in lowermost position, a counterweight, support means and a hanging cable which is arranged between the elevator cage and the counterweight and which compensates for the weight difference between the cage runs and the counterweight runs of the support means;

FIG. 1B shows the elevator installation according to FIG. 1A, wherein the elevator cage is disposed in its uppermost position;

FIG. 2A shows a second elevator installation in which an additional hanging cable is arranged between the counterweight and the shaft wall and the elevator cage is disposed in a lowermost position;

FIG. 2B shows the elevator cage according to FIG. 2A, wherein the elevator cage is disposed in an uppermost position;

FIG. 3 shows a section of a hanging cable according to the invention with weight elements fixed thereto;

FIG. 4 shows a cross-section through a hanging cable according to the invention with a weight element fixed on one side of the hanging cable;

FIG. 5 shows a cross-section through a hanging cable according to the invention with two weight elements each fixed on a respective side of the hanging cable;

FIG. 6 shows a cross-section through a hanging cable according to the invention with two weight elements fixed on each side of the hanging cable by clamping;

FIG. 7 shows a cross-section through a hanging cable according to the invention with cavities integrated in the casing thereof and filled with weight-increasing filling material; and

FIG. 8 shows two hanging cables according to the invention which are arranged in parallel and which are connected together by weight elements.

### DESCRIPTION OF THE INVENTION

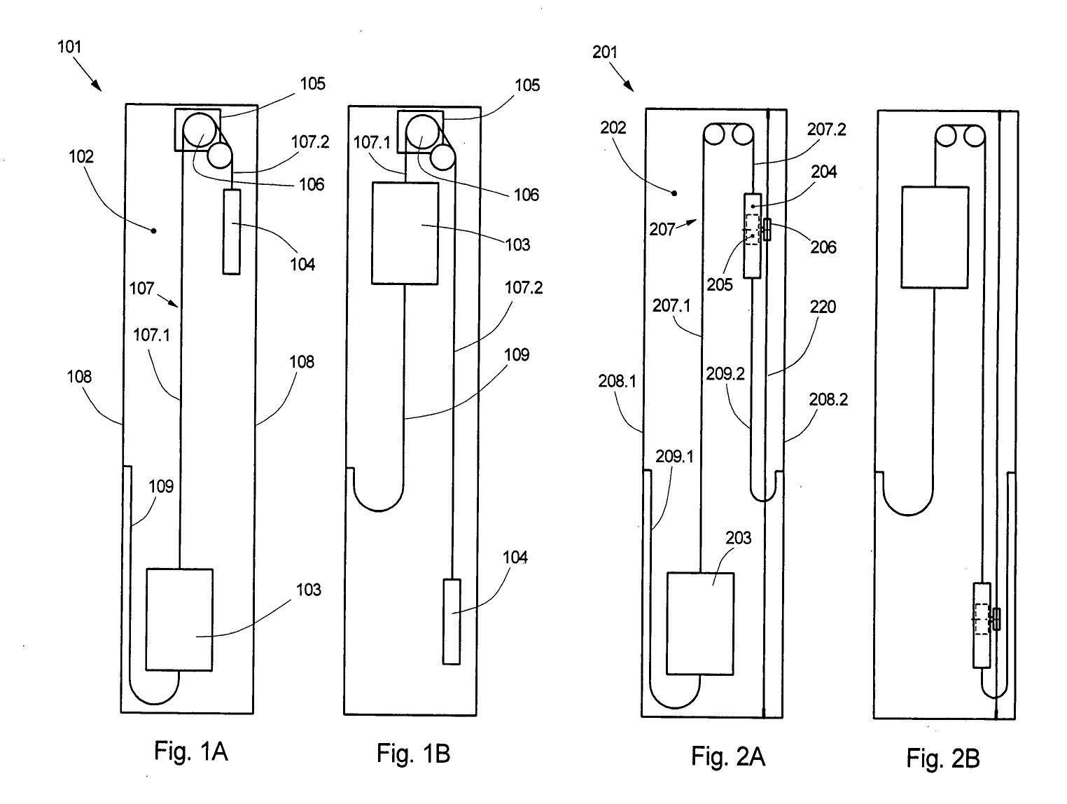

FIG. 1A shows a schematic cross-section through an elevator installation 101 with an elevator shaft 102, an elevator cage 103 and a counterweight 104, in which a drive unit 105 supports and drives the elevator cage and the counterweight by way of a drive pulley 106 and flexible support means 107. The elevator cage is illustrated in its lowermost position. A hanging cable 109 with integrated conductors and with means (not illustrated here) for increasing its weight per meter is arranged between the elevator cage 103 and a shaft wall 108 of the elevator shaft 102. This hanging cable 109 has, on the one hand, the task of transmitting energy and control signals to the elevator cage 103 and, on the other hand, of compensating for the influence of the weight forces of the two runs 107.1 and 107.2 acting on the drive pulley 106, the ratio of which changes in dependence on the position of the elevator cage.

FIG. 1B shows the elevator installation according to FIG. 1A, wherein, however, the elevator cage 103 is here illustrated in its uppermost position. It can be readily recognized from both FIGS. 1A and 1B that when the elevator cage is positioned at the bottom, the runs 107.1, which lead to the elevator cage, of the support means 107 have substantially greater weight than the runs 107.2 leading to the counterweight 104. By contrast thereto, in the case of the elevator cage positioned at the top (FIG. 1B) the runs 107.1, which lead to the elevator cage, of the support means 107 have a very much lesser weight than the runs 107.2 leading to the counterweight 104. Without additional weight compensating means the drive unit 104 would have to be designed so that it can overcome the torque, which results from the runs 107.1, 107.2 of the different length of the support means 107, at the drive pulley 106 additionally to the torque which results from the maximum difference between the weights of the fully loaded or empty elevator cage 103 and the counterweight 104. The hanging cable 109 provided with means for increasing its weight per meter provides compensation, in the elevator installation illustrated in FIG. 1A and 1B, in every position of the elevator cage 103 for the weight imbalance present between the two runs 107.1, 107.2 of the support means 107 so that the drive power of the drive unit 105 has to be designed only in correspondence with the maximum possible weight imbalance between the weight of the elevator cage and the weight. The weight per meter of the hanging cable 109 here corresponds with twice the summated weights per meter of the support means strands 107 present in parallel, wherein for attainment of the required weight per meter of the hanging cable 109 also two or more hanging cable strands can be arranged in parallel.

FIG. 2A and FIG. 2B show a second elevator installation 201 with an elevator cage 203 and a counterweight 204 in the two extreme positions of the elevator cage, wherein the elevator cage hangs at the cage runs 207.1, and the counterweight at the counterweight runs 207.2, of the support means 207. The drive unit 205 in this installation is arranged on the counterweight 304 and drives a drive pulley 206, which through co-operation with a stationary flexible drive strand 220 drives the elevator cage 203 hanging at the cage runs 207.1 and the counterweight 204 hanging at the counterweight urns 207.2. A first hanging cable 209.1 provided with means for increasing its weight per meter is led from a first shaft wall 208.1 of the elevator shaft 202 to the elevator cage 203 and a similar such second hanging cable 209.2 is led from a second shaft wall 208.2 of the elevator shaft 202 to the counterweight 204. This embodiment is practicable, because a respective hanging cable at least for the transmission of energy is required at each of the elevator cage 203 and the counterweight 204. The weight per meter of each of the two hanging cables 209.1, 209.2 here corresponds with the summated weights per meter of the support means strands present in parallel.

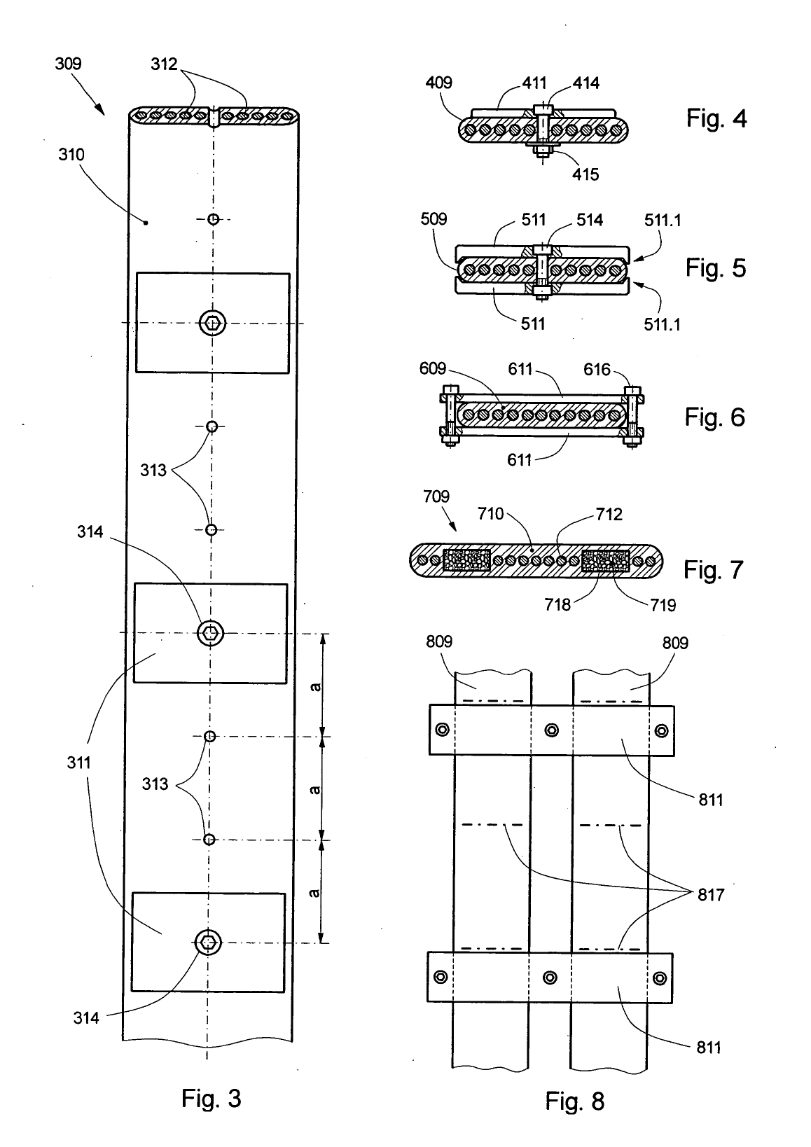

FIG. 3 shows a section of a hanging cable 309 according to the invention with weight elements 311 fixed thereto as means for increasing its weight per meter. The hanging cable 309 comprises a substantially flat casing 310 of flexible, extrudable material—for example of rubber or of resilient plastics material—in which electrically conductive metal strands 312 are embedded. In order to be able to fix the weight elements 311 to the hanging cable 309 this is provided along its length with a plurality of fastening holes 313, wherein always the same spacing “a” is present between adjacent fastening holes. Depending on the respectively required weight per meter of the hanging cable 309 weight elements with a single spacing “a” or with a multiple of the spacing “a” are fixed to the hanging cable, as is illustrated in detail in connection with FIGS. 4 and 5. Instead of screws other fastening or connecting elements such as, for example, rivets, blind rivets, snap connectors, etc., can obviously also be used. In correspondence with the required weight per meter, weight elements 311 are mounted either on only on e of the flat sides of the hanging cable 309 or on both sides, and in combination with the use of weight elements selected in correspondence with the weight per meter, which is to be achieved, from a series of available weight elements with different weight the weight per meter of the hanging cables can be adapted with a high level of accuracy to the specifics of the elevator installation.

FIG. 4 shows a cross-section through a hanging cable 409 according to the invention in which plate-shaped weight elements 411 are fixed on only one of the flat sides of the hanging cable. The fixing of the weight elements is carried out by a screw connection, wherein the shank of the screw 414 is inserted through one of the fastening holes present in the hanging cable at regular intervals. Advantageously a self-locking screw nut 415 is used for the screw connection. The embodiment according to FIG. 4 is particularly suitable for hanging cables of which the weight per meter to be increased only relatively slightly.

FIG. 5 shows a cross-section through a hanging cable 509 according to the invention, in which plate-shaped weight elements 511 are fixed on both flat sides of the hanging cable, wherein the weight elements have elevated lateral edges 511.1 which center and align the weight elements 511 relative to the hanging cable 509. The fixing of the weight elements 511 is similarly carried out by a self-locking screw connection, wherein the shank of the screw 514 is inserted through one of the fastening holes present in the hanging cable at regular intervals. The embodiment according to FIG. 5 is particularly suitable for hanging cables of which the weight per meter is to be increased relatively substantially.

FIG. 6 shows a cross-section through a hanging cable 609 according to the invention at which plate-shaped weight elements 611 are fixed on both flat sides of the hanging cable 609 exclusively by clamping. The weight elements 611 are so dimensioned that they protrude laterally beyond the hanging cable 609. The required clamping force is generated by clamping screws 616 which are arranged laterally adjacent to the hanging cable 609 and which connect together the two weight elements in the region of their ends protruding beyond the hanging cable. It is also advantageous to use self-locking screw connections here. The embodiment according to FIG. 6 is particularly suitable for commercially available hanging cables which are not provided with fastening holes.

FIG. 7 shows a cross-section through a hanging cable 709 according to the invention which has in the interior of its casing 710 integrated cavities 718 filled with weight-increasing filling material 719. The cavities 718 are produced and filled during production of the hanging cable, which is carried out by extrusion, wherein, for example, lead scrap, steel scrap, sand or metal layers made flexible by transverse notches can be used as filling material.

FIG. 8 shows an embodiment of the invention in which at least two hanging cables 809 arranged in parallel are connected together by a plurality of plate-shaped weight elements 811. The stability of the entire hanging cable equipment is thereby improved and the tendency thereof to oscillations strongly reduced.

In addition, markings 817 are illustrated in FIG. 8, which are present at the hanging cables 809 at regular intervals so as to facilitate fixing of the weight elements 811 at similarly regular intervals. The markings 817 can be formed, for example, in their production in the form of color markings, laser markings or impressed transverse grooves at the casing of the hanging cable. Such markings at the hanging cable are feasible in all of the embodiments of the present invention in which the regular intervals are not predetermined by fixing holes in the hanging cable.

Hanging cables which are exposed to relatively high additional loads due to the means for increasing their weight per meter can be furnished with tensile reinforcements in the form of steel or plastics material cables which are embedded in the same manner as the electrical conductors in the casing of the hanging cable and are individually fixed in the region of the fastening locations of the hanging cable.

The application of the weight elements is preferably carried out at the supplier preparing the components of the elevator. Obviously, the weight elements can also be fixed to the hanging cable or hanging cables for the first time on installation of the elevator, which is rational particularly in the case of hanging cable arrangements in which several hanging cables are connected together by weight elements.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. An elevator installation, comprising:
an elevator cage;
a counterweight;
at least one support means, which includes at least one cage run supporting the elevator cage and at least one counterweight run supporting the counterweight; and
at least one hanging cable with integrated conductors for transmission of energy and/or control signals, the hanging cable being arranged in the form of a hanging loop between a fixing point and the elevator cage or the counterweight, the hanging cable having means for increasing weight of the cable per meter.

2. The elevator installation according to claim 1, wherein the hanging cable provides compensation at least in part for a weight difference between the at least one cage run and the at least one counterweight run of the support means.

3. The elevator installation according to claim 2, wherein the weight increasing means includes weight elements fixed along the hanging cable.

4. The elevator installation according to claim 3, wherein the weight elements are fixed to the hanging cable at regular intervals.

5. The elevator installation according to claim 4, wherein the hanging cable is a flat cable, and the weight elements are fixed on at least one flat side of the cable.

6. The elevator installation according to claim 5, wherein fastening holes are present along the hanging cable.

7. The elevator installation according to claim 6, wherein fastening elements are inserted in the fastening holes for fixing the weight elements.

8. The elevator installation according to claim 5, wherein the weight elements along the hanging cable are fixed thereto exclusively by clamping fast.

9. The elevator installation according to claim 8, wherein markings facilitating positioning of the weight elements at regular intervals are present along the hanging cable at regular intervals.

10. The elevator installation according to claim 6, wherein several hanging cables are arranged in parallel and are connected together by plate-shaped weight elements.

11. The elevator installation according to claim 8, wherein several hanging cables are arranged in parallel and are connected together by plate-shaped weight elements.

12. The elevator installation according to claim 1, wherein the hanging has cable at least one cavity at least partly filled with weight increasing filling material for increasing the weight per meter of the hanging cable.

13. The elevator installation according to claim 12, wherein the cavity is a continuous longitudinal channel in the hanging cable.

14. The elevator installation according to claim 2, wherein compensation for the weight difference between the cage runs and the counterweight runs of the support means is provided completely and exclusively by the at least one hanging cable, which comprises means for increasing its weight by meter.

15. A method for configuring or installing an elevator installation, comprising the steps of installing at least one hanging cable with integrated conductors for transmission of energy and/or of: control signals to hang between a fixing point and an elevator cage or counterweight; and increasing the weight per meter of the hanging cable.

16. The method according to claim 15, including fixing weight elements along the hanging cable at regular intervals for increasing the weight per meter of the hanging cable.

17. The method according to claim 16, including adapting the weight per meter of the hanging cable to a given installation configuration by correspondingly selecting spacing (a) between individual weight elements, or weight of the individual weight elements, or both the spacing and the weight of the weight elements.

18. A method of producing a hanging cable with increased weight per meter, comprising the steps of providing at least one cavity extending parallel to energy and/or signal lines in the hanging cable; and at least partly filling the cavity with weight-increasing filling material.
